(19) United States
(12) Patent Application Publication
(10) Pub. No.: US 2007/0038512 A1
(43) Pub. Date: Feb. 15, 2007

(54) Product and service offering via website intermediary

(76) Inventors: Venkateshwara Reddy, Cupertino, CA (US); Joseph A. Nguyen, San Jose, CA (US)

Correspondence Address: Venkateshwara Reddy, 18740 Tilson Avenue, Cupertino, CA, 95014, US

(21) Appl. No.: 11/203,594

(22) Filed: Aug. 12, 2005

(51) Int. Cl. G06Q 30/00

(52) U.S. Cl. 705/14

(57) ABSTRACT

A computer-implemented method for displaying offering information to a website visitor visiting an intermediary website is disclosed. The intermediary website is associated with an intermediary that consolidates offering data from a plurality of sellers. The method includes ascertaining a status of the website visitor based on a unique identification associated with the website visitor, the status being one in a set of status that includes at least one of a new visitor to the intermediary website and a returning visitor with respect to one of the plurality of sellers. The method further includes displaying one of first offering data and second offering data on a webpage for viewing by the website visitor. The first offering data is displayed on the webpage if the website visitor is determined to be associated with a first status in the set of status. The second offering data is displayed if the website visitor is ascertained to be associated with a second status in the set of status.

### BACKGROUND OF THE INVENTION

With the tremendous popularity of the Internet, online commerce is on the rise. In the case of selling goods (or services), there are primarily two models that are used to sell the goods. A website may be owned and operated by a singular entity. Macys.com® for example handles both the commerce transaction and the order fulfillment (i.e., shipping of goods). Alternatively, a website may be owned by one entity but operated by an intermediary. Steve's Fishingpoles website for example is owned by Steve, but the commerce transaction portion therefor may be handled by an intermediary such as Amazon.com® or YahooShops®, which may also host (operate) the website. In the latter case, the intermediary's website handles the monetary portion of the commerce transaction and the website owner is responsible for order fulfillment.

The auction method is primarily dominated by several intermediary players such as eBay® or Yahoo®. Here the intermediary usually handles the bidding process and financial details. The fulfillment of the order is, however, left to the owner of the good(s) or service(s).

To be successful with an online business, it is important to either build a website that is extremely popular with web visitors, or use the services of an intermediary who already has done the hard work of building a visitor base. It is usually beyond the capability of most small businesses to build a website that is sufficiently popular that it can sustain a constant revenue stream for the seller. Therefore most sellers will use the services of an intermediary for either selling or auctioning their goods.

One disadvantage for the seller is that there are more choices for the visitor when the services of an intermediary are employed. In this situation, grabbing the attention of the visitor becomes paramount. Some intermediaries such as eBay® let sellers visually distinguish (using a technique such as highlighting) their list item so that it draws the attention of the visitor to the seller's product list item. This is done by, for example, adding special icons next to the list item, changing the font of the list item, allowing special placement of the list item on the screen. Such highlighting is applied equally to all visitors.

In the case of an intermediary who connects multiple sellers with a single visitor, such as Amazon.com®, a visitor is given a list of sellers for a particular product. This list of sellers is typically sorted by price; the cheapest seller is typically placed first on the list.

Currently on search engines such as Google®, paid advertisements are shown in a column next to search results. These advertisements are ranked based upon the amount of money the seller has paid to Google®.

Rank on the list or screen placement is very important, for example, a visitor's eyes tend to gravitate to the top-center of the display screen. The display resolution that a visitor has their video monitor set to can determine whether the visitor can see the entire contents of the page. Most visitors do not like to scroll down, and thus gravitate to viewing the top positions in a list.

The problem with current art is that the ordering in which the advertisements or list of sellers are shown are the same for any visitor using similar search criteria. There is no method for the seller to standout from the other sellers when a past customer, and/or new visitor, and/or a frequent visitor is the target of the advertisements or of a particular seller.

### SUMMARY OF THE INVENTION

The invention relates, in one embodiment, to a computer-implemented method for displaying offering information to a website visitor visiting an intermediary website, the intermediary website being associated with an intermediary that consolidates offering data from a plurality of sellers. The method includes ascertaining a status of the website visitor based on a unique identification associated with the website visitor, the status being one in a set of status that includes at least one of a new visitor to the intermediary website and a returning visitor with respect to one of the plurality of sellers. The method further includes displaying one of first offering data and second offering data on a webpage for viewing by the website visitor. The first offering data is displayed on the webpage if the website visitor is determined to be associated with a first status in the set of status. The second offering data is displayed if the website visitor is ascertained to be associated with a second status in the set of status.

In another embodiment, the invention relates to a computer-implemented method for displaying offering information to a website visitor visiting an intermediary website, the intermediary website being associated with an intermediary that consolidates offering data from a plurality of sellers. The method includes ascertaining a status of the website visitor based on a unique identification associated with the website visitor, the status being one in a set of status that includes at least one of a new visitor to the intermediary website and a returning visitor to the intermediary website. The method further includes automatically selecting an offering among available offerings from the plurality of sellers responsive to the ascertaining the status. The method additionally includes presenting the offering to the website visitor for selection, the offering being presented without simultaneously presenting other offerings of the available offerings.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows, in accordance with one embodiment of the present invention, the steps of influencing the position or placement of an advertisement.

FIG. 2 shows, in accordance with one embodiment of the present invention, the steps of influencing the position of a seller based on the price of the goods or services offered.

FIG. 3 shows, in accordance with one embodiment of the present invention, the steps for sorting sellers by ascertaining if special processing is to be applied to offerings by such sellers.

FIG. 4 shows, in accordance with one embodiment of the present invention, the steps of exchanging data between an intermediary, a seller or seller(s), and a visitor.

FIG. 5, shows in accordance with one embodiment of the present invention, the steps for gathering information from a seller.

FIG. 6, shows in accordance with one embodiment of the present invention the steps for a visitor to disclose their various visitor or user IDs to an intermediary for special processing.

FIG. 7 shows, in accordance with one embodiment of the present invention, the steps for matching a visitor with a list of visitors by an intermediary.

FIG. 8 details prior art search results.

FIG. 9 shows the results of applying one embodiment of the present invention.

FIG. 10 shows, in accordance with one embodiment of the present invention, the steps for applying special processing when a seller and a visitor want special processing.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

The invention allows a seller to specify to an intermediary special processing procedure(s) that may be applied to one or more visitors meeting the seller's parameters. If the visitor's status meets the seller's parameters, that visitor is accorded a different treatment compared to a visitor whose status fails to meet the seller's parameters.

For example, a seller who has listed a book for sale at a cost of $5.00 may wish to offer a 10% discount for a past customer who is interested in that book. By applying this discount, the rank of the seller in the list of sellers may have been influenced, or the screen placement of the seller's list item or a special icon may have been added to draw the attention of the visitor to convey the message that special consideration is being made based on the visitor's status.

The term seller and advertiser may be used interchangeably. The term buyer, user, and visitor may be used interchangeably. The term website and entity can be used interchangeably. The term product, goods and services can be used interchangeably.

In one embodiment, the seller can use a mechanism specified by the intermediary to generate offering information or offering data pertaining to a product, a service or advertisement. This advertisement will contain a message to be shown to the visitor. This message may contain, but not limited to price, product description, and/or hyperlinks.

The seller can use a mechanism specified by the intermediary to bid for desired rank on the search results page. One such method is to ask for a bid amount and have the intermediary calculate the approximate rank that can be obtained for the bid amount.

The seller can then inform the intermediary the seller's parameters for applying special treatment, such as which visitors are past customers of the seller. One such method is to periodically provide a list of email addresses or user ID's to the intermediary. Another such method may be to allow the intermediary to dynamically query the seller with a visitor ID to see if there is a match with the seller's parameters.

If there is a match, the seller can perform special processing based upon the status of a specific visitor. For example, the seller can allow for special processing based on the seller's perceived value of a specific visitor. Special processing procedures that the intermediary can apply may include an increment or decrement to the seller's bid price.

For example, if the seller knows that John is a knowledgeable and frequent shopper, the seller may wish not to have their advertisement prominently ranked or shown at all so as to maximize the screen area available for showing products that John may be likely to purchase. Note that a non-faithful shopper may in this case still get the list of products that she is likely to purchase but may have more of the screen area devoted to advertising to increase the probability of a sale. As another example, the seller may want their advertisement only to be prominently displayed when a new customer is detected.

A visitor to the intermediary's site should be uniquely identifiable. One such method is to have the visitor register with the intermediary. Registering involves giving a unique identifier such email address or login ID to the intermediary. The visitor can register with the intermediary any of the visitor's IDs that may help link the visitor to a seller. Another such method involves the intermediary identifying a visitor using Internet Protocol address, also known as IP address. In some cases it may be enough to know that visitor is new and doesn't need to be uniquely identifiable. Being new and unidentified is a status category.

Consider the example, when a visitor performs a search on the intermediary's website. In prior art, the results of the search are displayed along with advertising that has been deemed appropriate for the page. The advertising is usually ordered by the intermediary based upon the seller's preference of rank in the list and all pages look identical for all visitors performing identical searches.

In one embodiment of the invention, the intermediary will attempt to match the visitor IDs against the customer list of each seller or the visitor's characteristics against various lists of parameters by various sellers.

If there is a match, then the intermediary will apply any seller's specified special processing (such as, for example, a price adjustment to the bid based on the parameters the seller has specified). The ranks of the various sellers may change to reflect the adjusted bid amounts, and/or special markings maybe applied to the advertisement to indicate a special process has been applied to a particular seller.

In one embodiment of the invention, the intermediary may provide data to the seller. Said data may include but not limited to for example, information such as customer ID, name, and number of times the seller's ad was seen by visitor.

In one embodiment of the invention, the seller can register a product or service for sale with an intermediary. As a part of such registration, the seller may provide, but not limited to, data such as a price, description, condition of product.

Further, the seller can then specify or secure the rank of their product placement amongst a list of sellers for a similar product or service.

The seller can provide the intermediary with a list of customer(s) for special processing. The intermediary may also provide the seller with a list of customers. The customer list from the intermediary may be generated by the intermediary over a time period as the intermediary completes transactions on behalf of the seller. The seller may choose to also provide a list of customers to supplement or to replace the list provided by the intermediary. Such list may include data such as, but not limited to, total amount spent, amount of product returned, name, address, customer ID, and status.

The seller can determine which customer(s) on the customer list(s) are eligible for special processing. Special processing can also be applied to visitors not known to the seller, and/or to the intermediary.

As before, a visitor to the intermediary's site should be uniquely identifiable. If not identifiable, the visitor may be treated as a new visitor as a default.

One such method of identifying the visitor is to have the visitor register with the intermediary. Registering involves giving a unique identifier such email address or login ID to the intermediary. Another such method involves the intermediary identifying a visitor using Internet Protocol address, also known as IP address. In some cases it may be enough to know that visitor is new and doesn't need to be immediately or uniquely identifiable.

In prior art the visitor may have received a discount on a product at the discretion of the intermediary. In such a case, multiple sellers were not competing for the visitor.

In one embodiment of the invention, the visitor is given a choice to pick a seller from a list of sellers. Such choice can be automated by the intermediary based on the visitor's parameters. For example, the visitor could set a parameter where the lowest cost seller is automatically chosen and the visitor never sees a seller list.

In one embodiment of the invention, it is the seller who can set the parameters as to which visitor is eligible for special processing.

In one embodiment of the invention, there exist electronic commerce intermediaries that aggregate data from entities such as sellers. A seller is anyone who has a product or service for rent, sale or auction. Typically the data contains a list of item(s) for sale. The data may be collected from other entities by the intermediary using techniques such as web crawling. The data can also be sent to the intermediary by other entities using techniques known to those familiar with the art.

When a visitor uses the intermediary to obtain a list of sellers offering a desired product or service, such list is usually ordered by price of the product or some other criteria such as service ranking (i.e. how well did this seller perform past transactions with other past customers). Once that list is presented, the visitor may have the option to reorder the list based upon other parameters. Each item in the list is referred herein as a list item.

In prior art the sellers have no way of directly marketing to a visitor based on his status. In one embodiment of the current invention, the seller can transfer a customer list to intermediary. The intermediary may apply special processing to visitors whose status matches those specified by the seller(s). For example, for a matched visitor, the intermediary can adjust the price of the product. The intermediary can then position the seller accordingly, and/or the intermediary can place the seller in a more prominent place.

In the prior art, the seller of a product can pay the intermediary for special positioning on the screen, or have the intermediary make the seller's list item visually different from other sellers to draw attention away from other list items using a technique such as highlighting. In the prior art, note that positioning or highlighting of a list item is the same for every visitor using similar search criteria.

In one embodiment of the invention, the seller may transfer data to intermediary in advance. The intermediary can then use the data to relate a visitor to the intermediary with a seller.

The seller can flag individual or group of customers for special processing. One such special processing is to deny a transaction from a given customer. Another such special processing is, as mentioned, changing the price or bid or value.

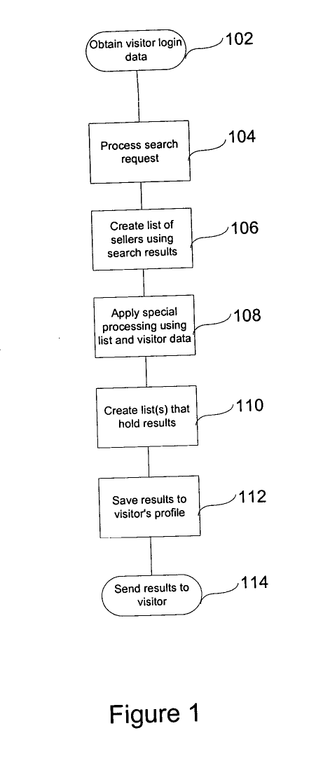

FIG. 1 shows, in accordance with one embodiment of the present invention, the steps of influencing the position or placement of an advertisement. In this example, the position or placement of advertisement(s) is influenced by the amount paid to the intermediary by the seller.

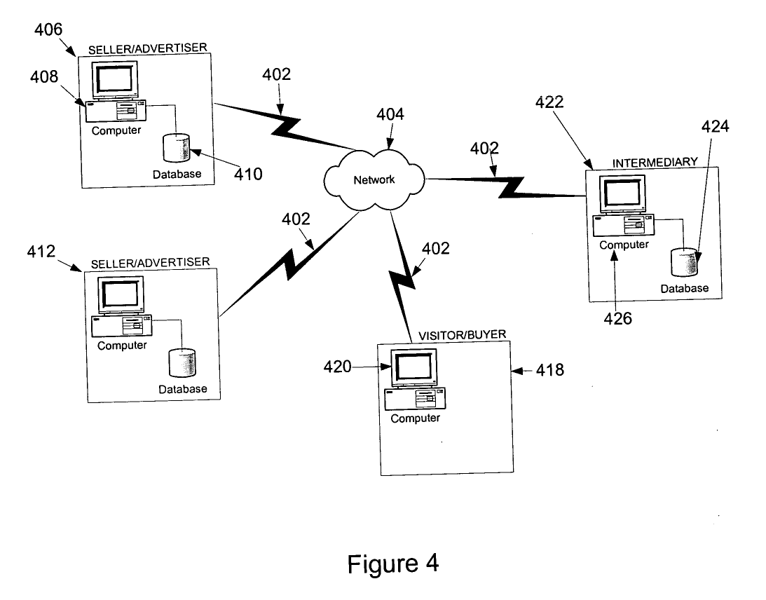

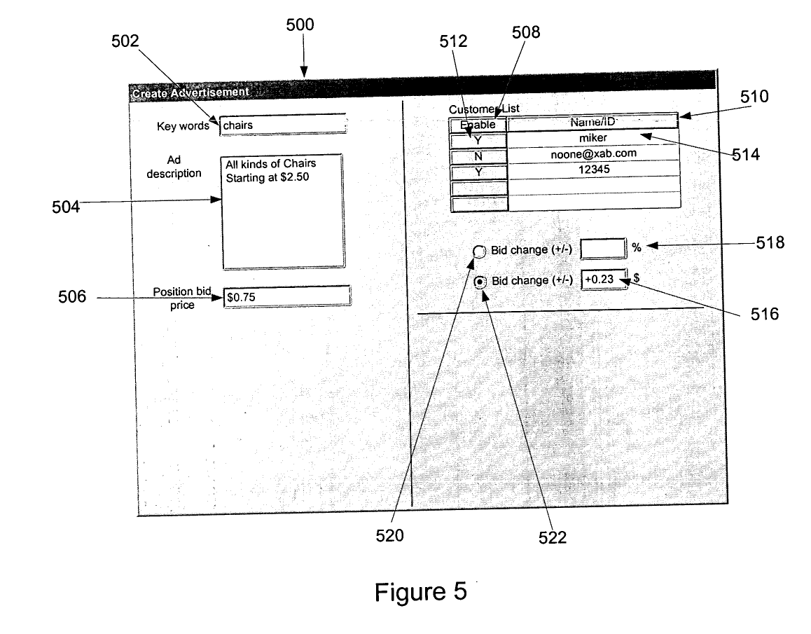

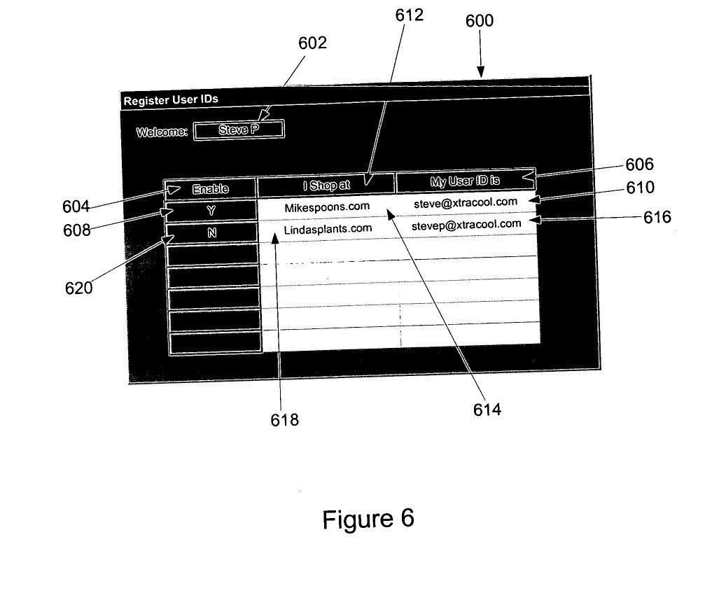

The necessary data, such as customer parameters, seller's parameters, visitor's parameters have been exchanged; see FIG. 4, FIG. 5, and FIG. 6.

In step 102, the visitor is on the intermediary's website. The visitor may login to the intermediary's website, or the intermediary may identify the visitor using an IP address or by reading a cookie from the visitor's system. Such techniques are known to those familiar with the art.

In step 104, the visitor may place a search request with the intermediary. Those familiar with the art realize that a combination of CGI and/or HTML and/or other appropriate technologies can be used to place the request.

In step 106, the search parameters are used to search one or more databases for data. The resulting data may be list(s) of news articles, links to websites, or advertisements. Prior art example can be found at the home page of Yahoo® (www.yahoo.com). In addition, one or more databases may be searched for sellers whose parameters meet the search parameters of the visitor. For example, John can search for razors or for merchants who have razors for sale. A database would be queried for sellers who wish to be processed when the search criteria contains the word razors. The results of this query are stored in list(s) in the computer's storage.

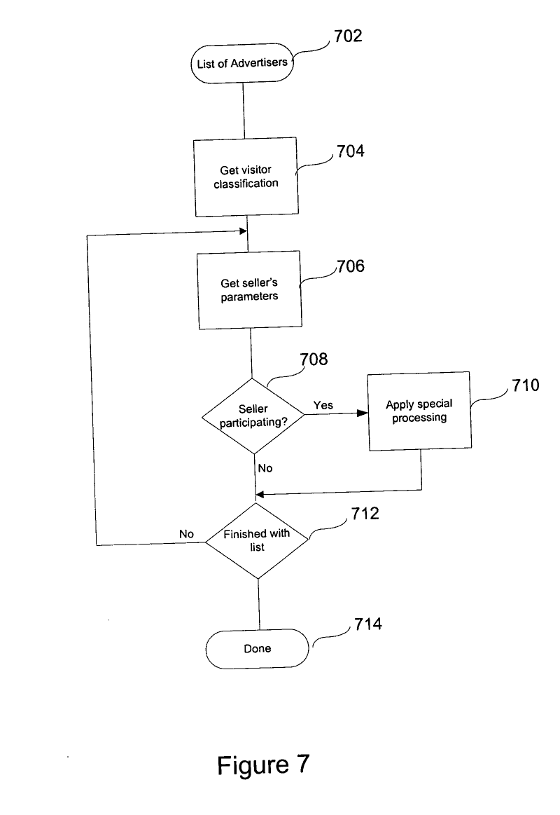

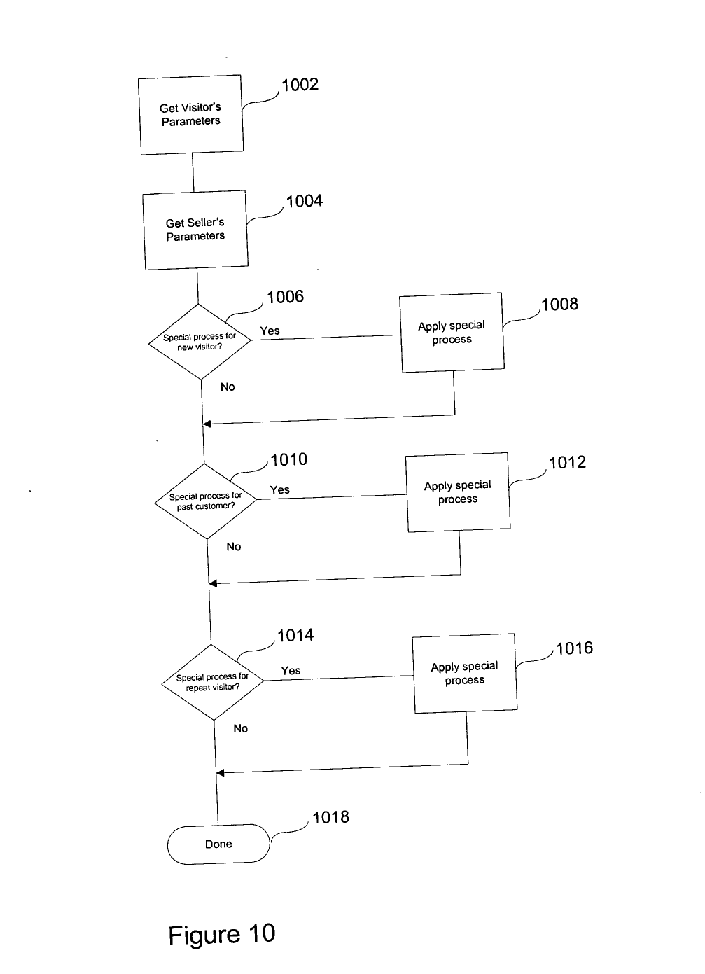

In step 108, a check is made to see if special processing needs to be applied before the results are sent to the visitor. See FIG. 7 and FIG. 10 for one method of special processing in the present invention.

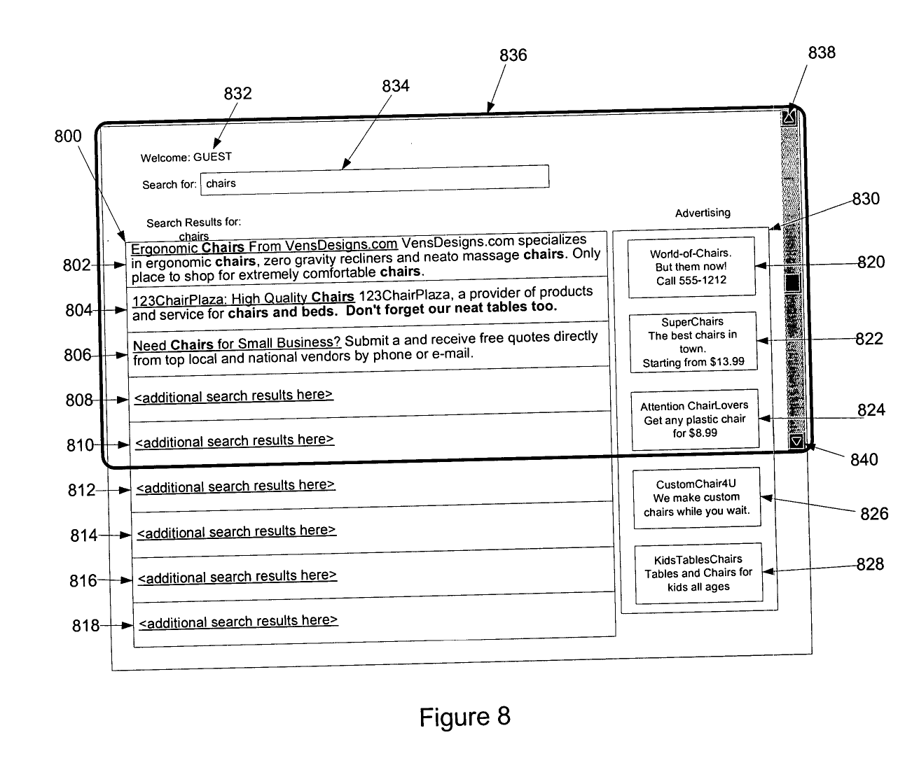

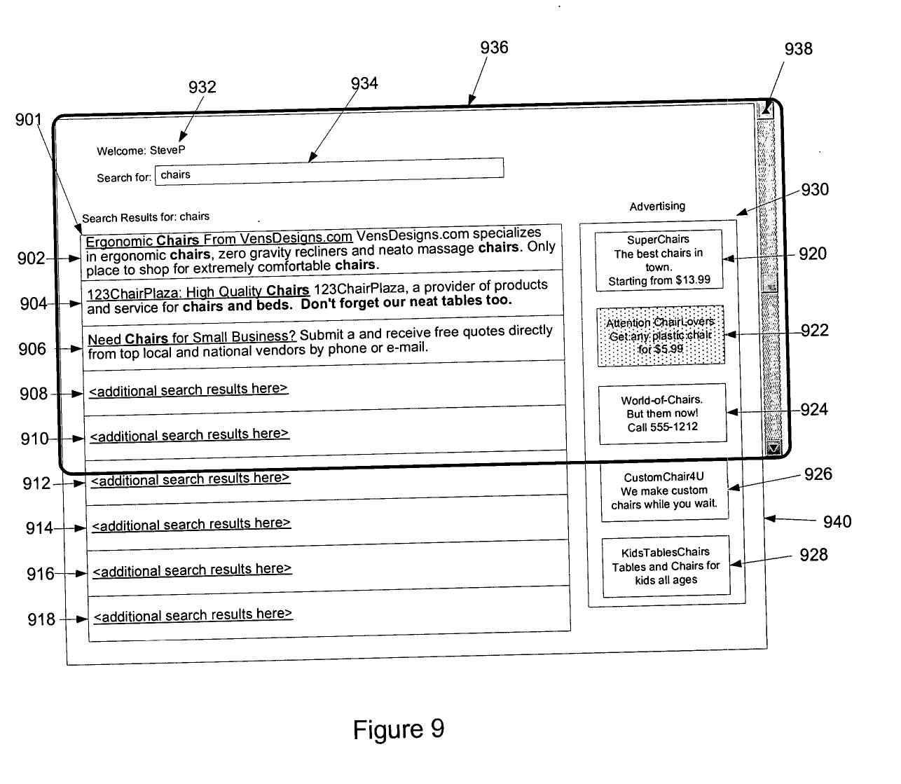

In step 110, the list of sellers that was generated in step 106 are sorted in a descending order using amount paid to intermediary. FIG. 8 shows the visitors display list before special processing and FIG. 9 shows the list after special processing.

In optional step 112, the list of sellers is saved to the visitor's profile. This can be used later to determine how many time a particular visitor has seen an advertisement from a particular seller.

In step 114, the results are sent to the visitor. In this example, the results are sent to the visitor using CGI and/or HTML coding. Again those familiar with the art are familiar with such techniques.

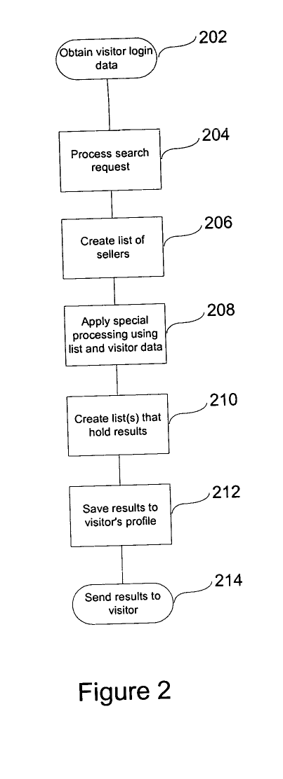

FIG. 2 shows, in accordance with one embodiment of the present invention, the steps of influencing the position of a seller based on the price of the goods or services offered.

The necessary data, such as customer parameters, seller's parameters, visitor's parameters have been exchanged; see FIG. 4, FIG. 5, and FIG. 6.

In step 202, the visitor is on the intermediary's website. The visitor may login to the intermediary's website. Or the intermediary may identify the visitor using an IP address or by reading a cookie from the visitor's system. Such techniques are known to those familiar with the art.

In step 204, the visitor may place a search request with the intermediary for an item such as a book, using the title or ISBN number. Those familiar with the art realize that a combination of CGI and/or HTML or other suitable technologies can be used to place the request.

In step 206, the search parameters are used to search one or more databases for data. The resulting data is a list of sellers for a given book title. In addition details of the book, such as author, number of pages, and table of contents are retrieved. Prior art example can be found at Amazon.com® (www.amazon.com). In addition, one or more databases may be searched for sellers whose parameters meet the search parameters of the visitor. The results of this query are stored in list(s) in the computer's storage.

In step 208, a check is made to see if special processing needs to be applied before the results are sent to the visitor. See FIG. 7 and FIG. 10 for one method of special processing in the present invention.

In step 210, the list of sellers that was generated in step 206 are sorted with the seller is special offering based on the visitor's status placed at the top of the list or in a location that is more prominent than otherwise for a visitor without the special status.

In step 212, the list of sellers is saved to the visitor's profile. This can be used later to determine how many times a particular visitor has seen a list item from a particular seller.

In step 214, the results are sent to the visitor. In this example, the results are sent to the visitor using CGI and/or HTML coding. Again those familiar with the art are familiar with such techniques.

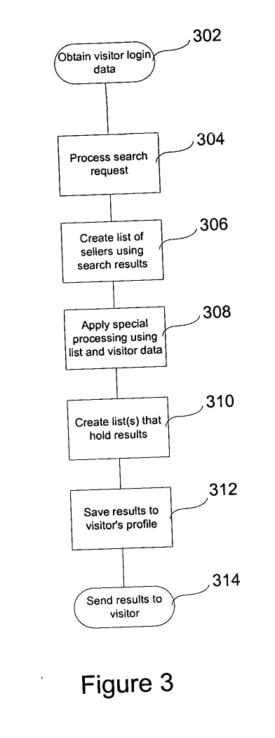

FIG. 3 shows, in accordance with one embodiment of the present invention, the steps for sorting sellers by ascertaining if special processing is to be applied to offerings by such sellers.

In step 302, the visitor is on the intermediary's website. The visitor may login to the intermediary's website. Or the intermediary may identify the visitor using an IP address or by reading a cookie from the visitor's system. Such techniques are known to those familiar with the art.

In step 304, the visitor places a request to have the intermediary return a list of sellers for the product specified by the visitor.

In step 306, the intermediary queries various databases for sellers of the product specified by the visitor.

In step 308, a check is preformed if all the sellers on the list of sellers have been processed. If no, then step 304. If yes, then step 310.

In step 310, the list of seller is sorted using one or more parameters that are specific to the visitor's unique status. Multiple sorted lists can be generated.

In step 312, a list of sellers is shown to the visitor. Techniques such as highlighting 922 can be employed as well.

In optional step 314, the results of the processing are sent to the visitor.

FIG. 4 shows, in accordance with one embodiment of the present invention, the steps of exchanging data between entities such as, intermediary 422, a seller(s) or seller(s) 406, 412 and a visitor 418. Exchange of data is done using a network 404, which each entity connects to using a network connection 402. Those familiar with the art realize there are different ways of connecting to a network, such as dial-up, broadband (DSL), fiber-optic, or wireless. In one embodiment of the present invention, the network that may be used is the Internet.

406 shows one possibility of a system configuration of a seller or seller. There is a computer 408, and a database 410. The database 410, may reside entirely in the computer or be partitioned into external and internal fractions.

412 shows the possibility of having more than one seller or seller.

418 shows one possibility of a system configuration of a visitor. There is a computer 420 which is connected to the network 404 by a network connection 402. There may exist more than one visitor 418.

Exchanging of data between the entities may include information such as HTTP protocols, XML files, and customer databases.

422 shows one possibility of a system configuration of an intermediary. There is a computer 426 which is connected to the network 404 by a network connection 402. There is a database 424 which is the intermediary may use to store visitors' and sellers' data.

FIG. 5, shows in accordance with one embodiment of the present invention, the steps for gathering information from a seller. The information collected may include, search terms 502, wording of an advertisement 504, amount willing to bid for a particular position on the advertisement list 506. A customer list is also sent. The list is made up of name(s), ID(s) of visitors 510, one or more flags to indicate allowing special processing for a particular customer 508. When the intermediary makes a match between the visitor and seller, the amount bid for placement can be changed 516 and 518 for example. The bid amounts can be activated 520 and 522 at the discretion of the seller. The data gathered may be sent to the intermediary using a format known to those skilled in the art such as XML.

In 514 the seller has entered a name/ID of a visitor that may be used by the intermediary for cross referencing or matching. In 512 the seller is indicating that they wish the intermediary to apply special processing for the identification juxtaposed to 512.

One skilled in the art will realized that unique parameters 518, 516, 520 and 522 can be applied to a select group of identifications or to individual identifiers. In addition those skilled in the art will also realize that form 500 can be implemented using various methods such as part of an application in Windows, a Java application or as HTML page.

FIG. 6, shows in accordance with one embodiment of the present invention the steps for a visitor to disclose their various visitor IDs to an intermediary for special processing. These steps are optional. The visitor has already registered or logged into the intermediary website and has been identified 602. The data that is requested is, website name of the seller 612, visitor ID used at that seller's website 606, and whether the visitor wants special processing 604 when a match is made by the intermediary. 608, 614, 610 show one entry. 620, 618, 616 show additional entry by the visitor. There may be zero or many entries in Form 600.

The identification that the visitor uses on the intermediary's website may not be the same identification that is used by the visitor at one or more sellers. Form 600, allows the intermediary to properly match the visitor to various sellers by cross referencing the identifications provided by the visitor. A security mechanism such may be implemented by the intermediary to prevent a visitor from using an identification that does not belong to him. For example, an email can be sent to a given identification requesting permission to use given identification.

The visitor is allowed to selectively opt out of the matching processing by the intermediary by changing the parameter value in column 604.

Those skilled in the art realize that Form 600 can be implemented using various methods such as an application in Windows, a Java application or as HTML page.

FIG. 7 shows, in accordance with one embodiment of the present invention, the steps for matching a visitor with a list of visitors by an intermediary.

In step 702, a list of sellers is accessed from a storage location.

In step 704, the visitor's classification is retrieved by the intermediary.

In step 706, a seller is taken from the list of sellers.

In step 708, a check is made to see if the seller is participating in special processing. This check is done by analyzing the seller's parameters they have registered with the intermediary. See FIG. 5. If the seller is participating, special processing is applied 710. If the seller is not participating then step 712.

In step 710, special processing is applied such as raising the seller's bid amount for position. The results of the special processing are stored back in the list.

In step 712, a check is made if there are more sellers on the list of sellers. If no, then step 706 to process another seller, else step 714.

In step 714, the intermediary is finished processing the list of sellers.

FIG. 8 details prior art search results 800. The system has identified the visitor as a “guest” 832. As discussed before, those familiar with the art realize there are numerous ways of identify a visitor to a website such as cookies, IP address, or login. The visitor can place a search request 834 to intermediary via the network, FIG. 4.

The intermediary processes the search request and returns the results 802, 804, 806, 808, 810, 812, 814, 816, 818. In addition the intermediary may also return a list of advertising 830 to the visitor as well. In this example, there are 5 advertisements sent back 820, 822, 824, 826, and 828. The box 836 is to simulate the visitors view port. The dimensions of the view port prevents the showing of the last four search results 812, 814, 816, and 818 and also the last two sellers 826 and 828. To view the out of bounds data the visitor has to scroll down the information. This can be done by using the up 838 or down 840 buttons.

In this example, the sellers 830 are ranked by the intermediary without regard to the visitor's status or identification. Position on the list is determined by the highest amount paid to the intermediary. In this example, the seller 820 bid was higher than sellers 822, 824, 826 and 828 and is thus displayed more prominently.

FIG. 9 shows, the results of applying one embodiment of the present invention. This example can be compared and contrasted with FIG. 8. The intermediary has identified the visitor 932. The visitor can submit a search request to the intermediary 934.

The intermediary processes the search request and returns the results 902, 904, 906, 908, 910, 912, 914, 916, 918. In addition the intermediary may also return a list of advertising 930 to the visitor as well. In this example, there are 5 advertisements sent back 920, 922, 924, 926, and 928. Note that advertisement 922 is now highlighted because the visitor ID parameters and special processing parameters match the visitor's status. Additionally or alternatively, the price to the visitor has changed from $3.99 to $5.99. In this example, the search result in box 830 is changed but it is contemplative that such special processing may also change the search result in box 901.

The box 936 is to simulate the visitors view port. The dimensions of the view port prevents the showing of the last four search results 912, 914, 916, and 918 and also the last two sellers 926 and 928. To view the out of bounds data the visitor has to scroll down the information. This can be done by using the up 938 or down 940 buttons.

FIG. 10 shows, in accordance with one embodiment of the present invention, the steps for applying special processing when a seller and a visitor want special processing.

In step 1002, the visitor's parameters are known to the intermediary.

In step 1004, the seller's parameters are known to the intermediary.

In step 1006, the seller's parameters are checked to see if the visitor's status of new visitor triggers the application of a special process. If yes, step 1008. If no, then step 1010.

In step 1008, the bid amount of the advertisement placement is changed 820, 924. Or the cost of the product is changed 824, 922.

In step 1010, the seller's parameters are checked to see if the visitor's status of past customer triggers the application of a special process. If yes, step 1012. If no, then step 1014.

In step 1012, the bid amount of the advertisement placement is changed 820, 924. Or the cost of the product is changed 824, 922.

In step 1014, the seller's parameters are checked to see if the visitor's status of repeat visitor triggers the application of a special process. If yes, step 1016. If no, then step 1018.

In step 1016, the bid amount of the advertisement placement is changed 820, 924. Or the cost of the product is changed 824, 922.

In step 1018, the information is stored back into the list of sellers or stored in another list.

As can be seen from above, the invention enables sellers to instruct the intermediary to allow special processing of the sellers offering for a visitor differently based upon the visitor's status and depending whether the visitor's status matches the parameters specified by the seller.

While this invention has been described in terms of several preferred embodiments, there are alterations, permutations, and equivalents which fall within the scope of this invention. It should also be noted that there are many alternative ways of implementing the methods of the present invention.

Having disclosed exemplary embodiments and the best mode, modifications and variations may be made to the disclosed embodiments while remaining within the subject and spirit of the invention as defined by the following claims.

What is claimed is:

1. A computer-implemented method for displaying offering information to a website visitor visiting an intermediary website, said intermediary website being associated with an intermediary that consolidates offering data from a plurality of sellers, comprising:
ascertaining a status of said website visitor based on a unique identification associated with said website visitor, said status being one in a set of status that includes at least one of a new visitor to said intermediary website and a returning visitor with respect to one of said plurality of sellers and;
displaying one of first offering data and second offering data on a webpage for viewing by said website visitor, said first offering data being displayed on said webpage if said website visitor is determined to be associated with a first status in said set of status, said second offering data being displayed if said website visitor is ascertained to be associated with a second status in said set of status.

2. The method of claim 1 wherein said first status of said website visitor is said returning visitor with respect to said one of said plurality of sellers, said first offering data being formed by changing a display position of offering data associated with said one of said plurality of sellers on said webpage.

3. The method of claim 1 wherein said first status of said website visitor is said returning visitor with respect to said one of said plurality of sellers, said first offering data including advertising specifically targeted to said website visitor.

4. The method of claim 2 wherein said advertising being selected based on a prior purchase history of said website visitor.

5. The method of claim 1 wherein said ascertaining employs a list of website visitors and their associated status, said list being furnished by said one of said plurality of sellers to said intermediary in advance of a visit by said website visitor.

6. The method of claim 5 where said list includes data pertaining to one of customer name, customer id, and a number of times individual customers in said list have visited said website.

7. The method of claim 1 wherein said ascertaining employs log-in data furnished by said website visitor when said website visitor logs into said intermediary website.

8. The method of claim 1 wherein said first status is said new visitor to said intermediary website, said first offering data being one of altering a price of an offering from said one of said plurality of sellers and changing advertising from said one of said plurality of sellers.

9. The method of claim 1 wherein said first offering data represents data pertaining to a product.

10. The method of claim 1 wherein said first offering data represents data pertaining to a service.

11. The method of claim 1 wherein said unique identification data is provided by said website visitor to said intermediary website, said unique identification data being configured to be recognizable by at least one seller of said plurality of sellers.

12. The method of claim 1 wherein said ascertaining employs intermediary-provided criteria, said intermediary-provided criteria being formulated without taking into account data from said plurality of sellers.

13. The method of claim 1 wherein said first status of said website visitor is said returning visitor with respect to said one of said plurality of sellers, said first offering data being formed by changing a display color of offering data associated with said one of said plurality of sellers on said webpage.

14. The method of claim 1 wherein said first status of said website visitor is said returning visitor with respect to said one of said plurality of sellers, said second offering data being formed by changing a display color of offering data associated with said one of said plurality of sellers on said webpage.

15. The method of claim 1 wherein said ascertaining further includes forwarding at least a subset of said unique identification to at least one of said plurality of sellers to ascertain said status.

16. The method of claim 1 wherein said ascertaining employs an IP address associated with said website visitor.

17. The method of claim 1 wherein said offering data is provided to seller to complete a transaction between seller and buyer.

18. The method of claim 1 where said offering data is provided to seller to provide status of transaction between intermediary and buyer.

19. A computer-implemented method for displaying offering information to a website visitor visiting an intermediary website, said intermediary website being associated with an intermediary that consolidates offering data from a plurality of sellers, comprising:
ascertaining a status of said website visitor based on a unique identification associated with said website visitor, said status being one in a set of status that includes at least one of a new visitor to said intermediary website and a returning visitor to said intermediary website;
automatically selecting an offering among available offerings from said plurality of sellers responsive to said ascertaining said status; and
presenting said offering to said website visitor for selection, said offering being presented without simultaneously presenting other offerings of said available offerings.

20. The method of claim 19 where said offering pertains to an auctioned product.
